(19) United States
(12) Patent Application Publication
(10) Pub. No.: US 2024/0175519 A1
(43) Pub. Date: May 30, 2024

(54) Systems And Methods To Detect And Monitor Valve Positioning In A Water Pipe Distribution System

(71) Applicant: Olea Networks, Inc., Bee Cave, TX (US)

(72) Inventors: Corey James Boelter, Round Rock, TX (US); Stefan Grefen, Nierstein (DE); Wariya Erez, Austin, TX (US); Anastasia Shikolay, Cedar Park, TX (US)

(21) Appl. No.: 17/994,555

(22) Filed: Nov. 28, 2022

(51) Int. Cl. F16K 37/00; G01F 15/00; G01F 15/18; G06T 7/00; G06T 7/11; G06T 7/70; H04N 23/11; H04N 23/56

(52) U.S. Cl. CPC F16K 37/0083; F16K 37/0091; G01F 15/005; G01F 15/185; G06T 7/001; G06T 7/11; G06T 7/70; H04N 23/11; H04N 23/56; G06T 2207/10048; G06T 2207/20021; G06T 2207/30108; G06T 2207/30204

(57) ABSTRACT

Embodiments of systems and methods are provided to detect the position of one or more valves utilized in a water pipe distribution system. In the system embodiments disclosed herein, identifying marker(s) are provided on, or attached to, at least one valve utilized in a water pipe distribution system. At least one camera is provided within the system for capturing images of the at least one valve over time. The images are processed to detect a location of the identifying marker(s) in the images and to determine a position of the at least one valve based on the location of the identifying marker(s) detected in the images.

### RELATED APPLICATION

The present application is related to co-pending U.S. patent application Ser. No. 17/154,410, filed Jan. 21, 2021, entitled “SYSTEM AND METHOD FOR DETECTING PROBLEMS WITHIN COMPOUND WATER METERS” and incorporated herein by reference.

### BACKGROUND OF THE INVENTION

### Field of the Invention

In general, the present disclosure relates to water pipe distribution systems and water meters having valves to control the flow of water there through. More specifically, the present disclosure relates to systems and methods to detect the position of such valves in a water pipe distribution system or water meter.

### Description of the Relevant Art

Water pipe distribution systems convey water from a water utility to a customer through a water meter while also determining the consumption amount of the customers water usage. These pipe systems can be complex and utilize various valves to control the flow of water there through. Compound water meters having a low flow pipe structure, a high flow pipe structure and bypass pipe structure are often used for commercial customers, due to the varying flow volumes utilized by such customers. The low flow, high flow and bypass sections include a variety of valves for directing water flow there through. In addition, the low flow and high flow sections each include a flow meter for measuring customer water usage, or consumption.

Compound water meters are used where high water flow rates are often necessary, but at other times low flow rates are present. In both cases, it is important to measure the water flow through the meter. That is, a compound water meter should have the ability to measure over wide flow rate ranges including low flow sensitivity and high flow rate capacity. Compound water meters are typically used with commercial water customers such as schools, factories, apartment buildings, hotels, hospitals, office buildings and industrial users. It is important to measure the water flow to such customers over a wide range to accurately charge for their water usage, which also promotes water conservation and saves the utility and customer money. Although compound water meters can be installed above-ground, they are often disposed below ground within a water meter pits, or vaults.

Water pipe distribution infrastructures are typically old, often costly to upgrade, and may have defects that are hard to diagnose. For instance, in municipal water supply systems, up to 20% of water is assumed to be lost due to leaks in these piping systems. Because leaks are difficult and costly to find, this often is not attempted. Another problem are underreporting water meters, which may be caused by normal wear and tear, or a premature failure of parts under adverse conditions. For instance, mechanical flow meters may be affected by sediment build-up within the piping distribution system or the occurrence of back pressure in the pipe, which may lead to gradual, sudden, or catastrophic failures. Both leaks in the vicinity of compound water meters and underreporting compound water meters are difficult to identify, particularly with legacy compound water meters.

Another source for underreporting water meters is that caused by the intentional or unintentional diversion of water from the primary region of the compound water meter. Most compound water meters include a bypass section having a bypass valve that allows for maintenance. Some compound water meters may also include shut off valves on either the low flow or high flow sections of the compound water meter. In some cases, the bypass valve may be intentionally opened to divert water flow through the bypass section, thereby completely or partially bypassing the flow meters in the high flow and low flow sections of the compound water meter. An open bypass valve (otherwise referred to as a “bypass open condition”) can lead to dramatic underreporting of water consumption and lost revenue for the water utility. It would be desirable to monitor the positioning of the bypass valve to detect intentional, or unintentional, bypass open conditions and reduce underreporting.

### SUMMARY OF THE INVENTION

Various embodiments of systems and methods are provided herein to detect the positioning of one or more valves utilized in a water pipe distribution system. In the system embodiments disclosed herein, identifying marker(s) are provided on, or attached to, at least one valve utilized in a water pipe distribution system, and at least one optical sensor (e.g., camera) is provided for capturing images of the at least one valve over time. The images are processed (e.g., locally or remotely) to detect a location of the identifying marker(s) in the images and to determine the positioning of the at least one valve based on the location of the identifying marker(s) detected in the images. The at least one valve may generally comprise a wide variety of valves, which are utilized to control water flow within a water pipe distribution system.

In some embodiments, the systems and methods disclosed herein may be used to determine the position of one or more valves included within a compound water meter distribution system, which may be above-ground or disposed within a water meter pit or a vault. In at least one preferred embodiment, the systems and methods disclosed herein may be used to monitor the position of a bypass valve, which is included within a compound water meter. By monitoring the position of the bypass valve, the systems and methods disclosed herein may be used to detect bypass open conditions, if and when they occur. Although described herein in the context of detecting the positioning of a bypass valve included within a compound water meter, the techniques described herein are not strictly limited to bypass valves may also be used to detect the positioning of other valves utilized within a compound water meter and/or other valves included within a water pipe distribution system.

According to one embodiment, a system is provided to determine a position of one or more valves utilized in a water pipe distribution system. The system may generally include: an identifying marker provided on, or attached to, at least one valve included within a compound water meter for controlling water flow through the compound water meter; at least one camera coupled to capture images of the at least one valve over time; and a processing device coupled to receive the images captured by the at least one camera system. The processing device may be configured to execute program instructions stored within a computer readable medium to detect a location of the identifying marker in the images and determine a position of the at least one valve based on the location of the identifying marker detected in the images.

In some embodiments, the compound water meter and the at least one camera may be disposed below ground within a water meter pit. When disposed below ground, the at least one camera may include an infrared (IR) light source and photodetector, and the identifying marker may comprise a reflective device or a reflective material that is provided on, or attached to, the at least one valve. For example, the reflective device or the reflective material may be selected from a group consisting of: an IR device, a reflective tape, a reflective paint, and light colored materials that do not significantly absorb light. The at least one camera may be mounted to a variety of surfaces and structures within the water meter pit and may be positioned, so that the at least one valve is within a field of view (FOV) of the at least one camera. For example, the at least one camera may be mounted to an inner surface of the water meter pit.

In other embodiments, the compound water meter and the at least one camera may be disposed above ground. When disposed above ground, the at least one camera may include a visible spectrum light source and photodetector, and the identifying marker provided on, or attached to, the at least one valve may comprise an identifiable feature of the at least one valve or an identifiable device or material attached to the at least one valve. The at least one camera may be mounted on a wide variety of above ground mounting surfaces and may be positioned, so that the at least one valve is within a field of view (FOV) of the at least one camera. In some embodiments, for example, the at least one camera may be mounted to a solar panel, which is coupled to provide power to one or more components of the compound water meter.

The system disclosed herein may be used to determine the position of a variety of different valves utilized in a water pipe distribution system. In some embodiments, for example, the at least one valve may be a bypass valve, which is coupled to a bypass section of the compound water meter to control water flow through the bypass section. In such embodiments, the processing device may execute the program instructions to determine the position of the bypass valve to monitor for bypass open conditions. In other embodiments, the at least one valve may be coupled to a high flow section, a low flow section or a test port of the compound water meter. In such embodiments, the processing device may execute the program instructions to determine the position of the at least one valve and monitor for changes in the position and/or tampering of the at least one valve. In some embodiments, the compound water meter may include a plurality of valves, and the at least one camera may include a plurality of cameras, which are coupled to capture images of one or more of the plurality of valves over time.

In some embodiments, the program instructions executed by the processing device may detect the location of the identifying marker in each image by: (a) dividing the image into a pixel grid; (b) assigning an (x, y) coordinate system to the pixel grid; and (c) determining (x, y) coordinates in the pixel grid that correspond to the location of the identifying marker in the image. In other embodiments, the program instructions executed by the processing device may detect the location of the identifying marker in each image by: (a) converting the image to a binary image; (b) dividing the image into a pixel grid; (c) assigning an (x, y) coordinate system to the pixel grid; and (d) determining (x, y) coordinates in the pixel grid that correspond to the location of the identifying marker in the image. In such embodiments, the program instructions executed by the processing device may determine the position of the at least one valve based on the (x, y) coordinates that correspond to the location of the identifying marker detected in the image. In some embodiments, the processing device may be further configured to execute the program instructions to detect a change in the position of the at least one valve and generate an alert in response to the change.

In some embodiments, the processing device may be further configured to use sensor data obtained from one or more sensors coupled to the compound water meter to confirm the position of the at least one valve. For example, the one or more sensors comprise one or more of the following sensors: (a) a pressure sensor coupled to a pipe structure controlled by the at least one valve, wherein the pressure sensor senses water pressure within the pipe structure and generates sensor data corresponding to the sensed water pressure; (b) a vibration sensor coupled to the at least one valve or the pipe structure controlled by the at least one valve, wherein the vibration sensor senses vibration in the pipe structure indicative of water flow through the pipe structure and generates sensor data corresponding to the sensed vibration; and (c) a motion sensor coupled to the least one valve, wherein the motion sensor senses movement of the at least one valve and generates sensor data corresponding to the sensed movement.

According to another embodiment, a method is provided herein to determine a position of at least one valve utilized in a water pipe distribution system. The method may generally include capturing images of the at least one valve over time, wherein the at least one valve comprises an identifying marker that is captured in the images; detecting a location of the identifying marker in each of the images; and determining a position of the at least one valve in each of the images based on the location of the identifying marker detected in the images.

In some embodiments, said detecting the location of the identifying marker may include detecting a first location of the identifying marker in a first image captured at a first time; and detecting a second location of the identifying marker in a second image captured at a second time, which is greater than the first time.

In some embodiments, said determining the position of the at least one valve may include determining a first position of the at least one valve in the first image based on the first location of the identifying marker detected in the first image; and determining a second position of the at least one valve in the second image based on the second location of the identifying marker detected in the second image.

In some embodiments, the method may further include comparing the second position to the first position to determine if the position of the at least one valve has changed; and generating an alert when the position of the at least one valve changes.

### BRIEF DESCRIPTION OF THE DRAWINGS

A more complete understanding of the present inventions and advantages thereof may be acquired by referring to the following description taken in conjunction with the accompanying drawings, in which like reference numbers indicate like features. It is to be noted, however, that the accompanying drawings illustrate only exemplary embodiments of the disclosed concepts and are therefore not to be considered limiting of the scope, for the disclosed concepts may admit to other equally effective embodiments.

FIG. 1 is top-down view into an example water meter pit including a compound water meter and at least one camera for capturing images of at least one valve included within the compound water meter, wherein the at least one valve comprises an identifying marker that is captured in the images;

FIG. 2 is another top-down view into an example water meter pit including a compound water meter and multiple cameras for capturing images of at least one valve included within the compound water meter, wherein the at least one valve comprises an identifying marker that is captured in the images;

FIG. 3 is a block diagram of a system in accordance with one embodiment of the present disclosure;

FIGS. 4A-4H illustrate how the techniques disclosed herein may be utilized, in accordance with one embodiments of the present disclosure, to detect the location of one or more identifying markers in the images captured by at least one camera, and determine a position of at least one valve based on the location of the identifying marker(s) detected in the images; and

FIG. 5 is a flowchart diagram illustrating one embodiment of a method that may be used to determine a position of at least one valve utilized in a water pipe system.

### DETAILED DESCRIPTION OF THE PREFERRED EMBODIMENTS

The present disclosure provides various embodiments of systems and methods that may be used to detect the position of one or more valves utilized in a water pipe distribution system. In the system disclosed herein, identifying marker(s) are provided on, or attached to, at least one valve utilized in the water pipe distribution system. At least one camera is provided within the system for capturing images of the at least one valve over time. The images are processed to detect a location of the identifying marker(s) in the images and to determine a positioning of the at least one valve based on the location of the identifying marker(s) detected in the images.

In some embodiments, the systems and methods disclosed herein may be used to determine the position of one or more valves included within a compound water meter, which may be above-ground or disposed within a water meter pit and/or a vault. In at least one preferred embodiment, the systems and methods disclosed herein may be used to monitor the position of a bypass valve, which is included within a compound water meter. By monitoring the position of the bypass valve, the systems and methods disclosed herein may be used to detect bypass open conditions, if and when they occur. Although described herein in the context of detecting the positioning of a bypass valve included within a compound water meter, the techniques described herein are not strictly limited to bypass valves may also be used to detect the position of other valves utilized within a compound water meter and/or other valves included within a water pipe distribution system.

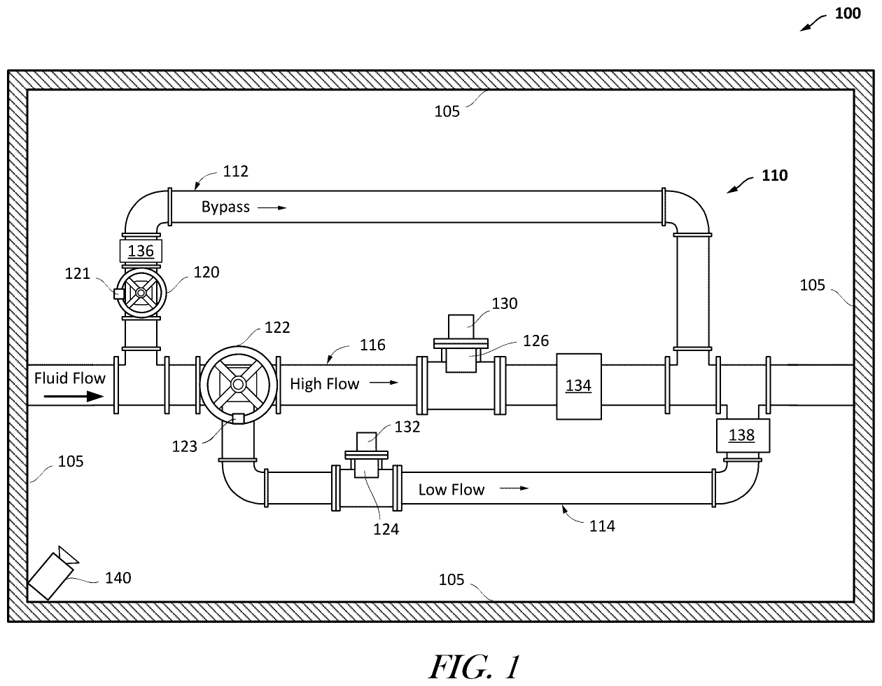

FIG. 1 illustrates one embodiment of a compound water meter 110 disposed within a water meter pit 100. As shown in FIG. 1, compound water meter 110 is illustrated as having a pipe distribution system that includes a bypass section 112, a low flow section 114 and a high flow section 116. The compound water meter 110 shown in FIG. 1 also includes a plurality of valves. For example, a bypass valve 120 is provided within the bypass section 112 for controlling water flow through the bypass section 112. A main valve 122 is positioned at the junction of the high flow section 116 and the low flow section 114 to control water flow through the high flow and low flow sections. The main valve 122 allows water into the low flow section 114 until the pressure at a crossover valve (not shown), within the high flow section 116, reaches a certain level (determined by meter manufacture). Once the pressure at the crossover valve reaches the certain level, water is diverted mainly into the high flow section 116.

As shown in FIG. 1, flow meters 124 and 126 are provided within the low flow section 114 and the high flow section 116, respectively, for monitoring the fluid flow through those sections. In one embodiment, flow meters 124, 126 may be implemented as turbine flow meters. As known in the art, a turbine flow meter has a turbine section that rotates with fluid flow and drives the reading on a register provided on the top of the meter as water flows through the meter. The rotation speed of the turbine varies with the speed of the fluid flow, and the rotation count per volume unit is translated into a flow volume for that specific time. A turbine flow meter typically displays the cumulative throughput (e.g., flow volume units) that passed through the pipe since installation of the flow meter, or since its last reset. It also may display the rate of throughput (e.g., the flow rate), which is equivalent to the first derivative of the function that models the cumulative throughput.

The compound water meter 110 shown in FIG. 1 depicts a configuration of a compound water meter that may be used in a water meter pit 100 disposed between the utility pipe distribution system and a commercial user—left to right in FIG. 1. In this configuration, water flows from the utility pipe distribution system through main valve 122 into the low flow section 114 to the commercial user. At some point, higher water pressure may cause the crossover valve, within section 116, to begin to open, allowing water to flow partially through the low flow section 114 and partially through the high flow section 116. As water pressure increases, the crossover valve opens more fully, allowing more water flow through the high flow section 116. The bypass section 112 and bypass valve 120 are included within the compound water meter 110 for maintenance purposes. Opening of the bypass valve 120 permits both the low flow and high flow meters 124, 126 to be bypassed with the closing of the main valve 122 and allowing water flowing directly to the commercial user.

As water flows through the low flow section 114 and the high flow section 116, flow meters 124, 126 record various parameters of the fluid flow, such as for example, cumulative throughput (e.g., flow volume units), rate of throughput (e.g., flow rate), etc. In some embodiments, sensor packages 130, 132 may be included within, or coupled to, the flow meters 124, 126 to record various parameters concerning operation of the flow meters 124, 126. Each sensor package 130, 132 may generally include a number of sensors.

In one embodiment, each sensor package 130, 132 may include an optical sensor, a magnetic sensor and a vibration sensor, as described in co-pending U.S. patent application Ser. No. 17/154,410, which is entitled “SYSTEM AND METHOD FOR DETECTING PROBLEMS WITHIN COMPOUND WATER METERS”, and incorporated herein by reference. The optical sensor may be used to read the register on the meter display of the flow meters 124, 126 to obtain a reading of one or more measurements and/or indicators provided thereon. For example, the optical sensor may be used to obtain a reading of the cumulative throughput (e.g., flow volume units) that passes from the water utility to the customer and/or the rate of throughput (e.g., the flow rate). The magnetic sensor (e.g., a hall effect sensor) directly measures movement of the meters measuring element(s), which indicates operation and indirect measurement of the meter consumption. The vibration sensor is typically a MEMS sensor, which detects vibration in the pipes indicative of water movement in the pipes.

In some embodiments, additional sensor package(s) may be included within the compound water meter 110 to determine the water pressure at various points within the compound water meter 110 and/or to record other environmental data. In the embodiment shown in FIG. 1, sensor packages 134, 136 and 138 are coupled to the high flow section 116, the bypass section 112 and the low flow section 114, respectively. In some embodiments, sensor packages 134, 136 and 138 may each include a pressure sensor for measuring the water pressure in the respective section. In some embodiments, sensor packages 134, 136 and 138 may additionally or alternatively include other sensors to record environmental data, such as, e.g., vibration signals, intra-pipe pressure, chemical properties of the water, air humidity and/or ambient temperature.

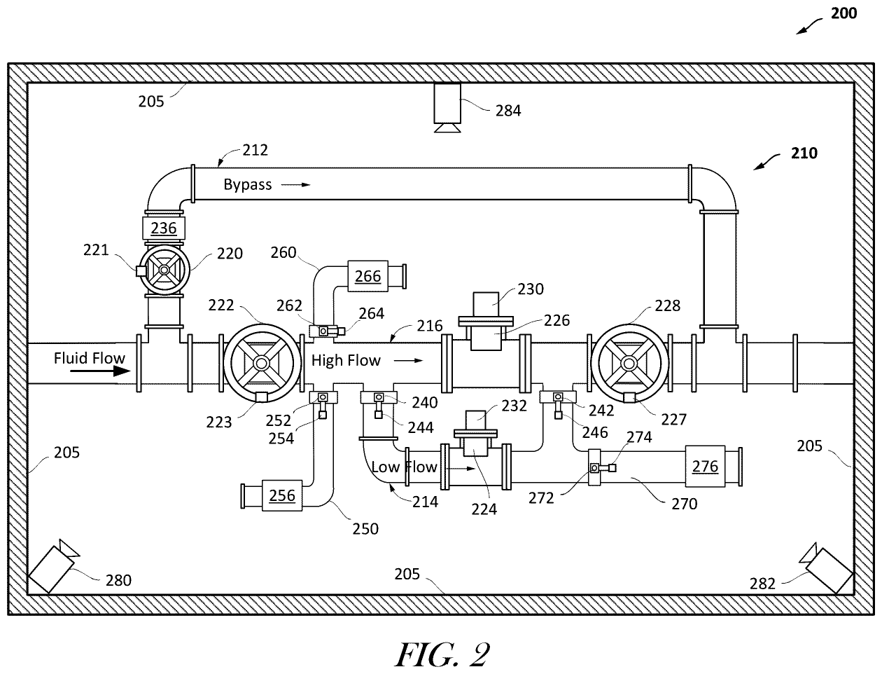

FIG. 2 illustrates another embodiment of a compound water meter 210 that may be disposed within a water meter pit 200. Similar to the embodiment disclosed above, compound water meter 210 may generally include a bypass section 212, a low flow section 214 and a high flow section 216. A low flow meter 224 and a high flow meter 226 are provided within the low flow section 214 and the high flow section 216, respectively, for monitoring the fluid flow through those sections. Flow meters 224 and 226 may be generally implemented as described above. In one embodiment, flow meters 224, 226 may be implemented as turbine flow meters, as discussed above.

Like the compound water meter 110 shown in FIG. 1, the compound water meter 210 shown in FIG. 2 also includes a plurality of valves. For example, a bypass valve 220 is coupled to the bypass section 212 to control water flow through the bypass section 212. In addition, a main valve 222 is provided on the inlet side, and a discharge valve 228 is provided on the outlet side, of the high flow section 216. Similar to the main valve 122 shown in FIG. 1, the main valve 222 is configured to direct water into the low flow section 214 and high flow section 216 until pressure at a crossover valve (not shown) reaches a certain level. Once the pressure at the crossover valve reaches the certain level, water is mainly diverted into the high flow section 216. The main valve 222 and the discharge valve 228 also have a manual override function (e.g., a shut-off valve), which can be manually operated to prevent water flow through the high flow and low flow sections. An inlet ball valve 240 is also provided on the inlet side, and an outlet ball valve 242 is provided on the outlet side, of the low flow section 214 to control water flow through the low flow section 214, used for maintenance.

In some embodiments, the compound water meter 210 may include one or more test ports and one or more additional valves to control water flow into/through such test ports. In the embodiment shown in FIG. 2, for example, compound water meter 210 include a first test port 250, a second test port 260 and a third test port 270. Inlet ball valves 252, 262 and 272 are respectively provided on the first test port 250, the second test port 260 and the third test port 270 to control water flow into the test ports. Although illustrated at particular locations within the compound water meter 210, the location of one or more of the test ports and/or the inlet ball valves may vary depending on utility and meter configuration.

The compound water meter 210 shown in FIG. 2 depicts another configuration of a compound water meter that may be used in a water meter pit 200 disposed between the utility pipe distribution system and a commercial user—left to right in FIG. 2. In this configuration, water flows from the utility pipe distribution system through the main valve 222 into either the low flow section 214 or the high flow section 216 to the commercial user, depending on the incoming water pressure. As water flows through the low flow section 214 and/or the high flow section 216, flow meters 224, 226 record various parameters of the fluid flow, such as for example, cumulative throughput (e.g., flow volume units), rate of throughput (e.g., flow rate), etc. The bypass valve 220 is provided within the bypass section 212 of the compound water meter 210 for maintenance purposes. When the bypass valve 220 is opened, and the main valve 222 is closed, water flow is diverted through the bypass section 212, which enables water to bypass the low flow and high flow meters 224, 226 and flow directly to the commercial user.

In some embodiments, sensor packages 230, 232 may be included within, or coupled to, the flow meters 224, 226 to record various parameters concerning operation of the flow meters 224, 226. Like the sensor packages 130, 132 shown in FIG. 1 and described above, the sensor packages 230, 232 provided within compound water meter 210 may each include an optical sensor, a magnetic sensor, and a vibration sensor, in some embodiments. Additional sensors may also be included within the compound water meter 210 to determine water pressure, vibration, temperature, and water quality within the compound water meter 210. For example, an additional sensor 236 (e.g., a pressure sensor or vibration sensor) may be coupled to (or arranged within) the bypass section 212 to detect water flow/pressure through the bypass section. In some embodiments, additional sensors (not shown) may be coupled to (or arranged within) the low flow section 214, high flow section 216 or elsewhere within the compound water meter 210 to measure the water flow/pressure in the respective section and/or detect leaks.

In some embodiments, additional sensor(s) may be coupled to (or arranged within) one or more of the test ports provided within the compound water meter 210. For example, one or more additional sensors 256 may be provided on/within the first test port 250, which is arranged near an inlet side of the compound water meter 210 and controlled by a first inlet ball valve 252. In one example implementation, the additional sensor(s) 256 may include a water pressure sensor to measure the water pressure of the incoming fluid flow and a temperature sensor to measure the temperature of the incoming fluid flow or an ambient temperature surrounding compound water meter 210. Additional sensor(s) 266 may also be provided on/within the second test port 260, which is coupled near the inlet side of the compound water meter 210 and controlled by a second inlet ball valve 262. In one example implementation, the additional sensor(s) 266 may include a water quality sensor (e.g., a chemical sensor) that measures various chemical properties of the incoming fluid flow, such as acidity (pH), metals/trace elements, turbidity, or quantity of an additive. In some embodiments, additional sensor(s) may also be provided on/within the third test port 270, which is coupled to the low flow section 214 and controlled by a third inlet ball valve 272, for measuring additional characteristics of the fluid.

In some embodiments, a power source or power generator may be provided within or coupled to the compound water meter 210 for supplying electrical power to one or more components of the compound water meter 210, such as for example, the sensor packages, additional sensors and/or edge data collection module (not shown). In one example implementation, a solar panel and rechargeable battery (not shown) may be used to supply electrical power to one or more of components of the compound water meter 210. In another example implementation, a hydro-electric generator (e.g., hydrometer) may be provided within the compound water meter 210 to convert the energy of flowing water into electric energy, which is supplied to one or more components of the compound water meter 210. In the particular embodiment shown in FIG. 2, hydro-electric generator 276 is coupled to the third test port 270. However, the hydro-electric generator 276 is not strictly limited to such placement and may be alternatively arranged in other embodiments. For example, the hydro-electric generator 276 may be alternatively coupled to the first test port 250, the second test port 260 or within another test port not specifically shown herein.

In the embodiments shown in FIGS. 1 and 2, the sensor data obtained from the sensors is preferably time stamped, so that the sensor data can be analyzed to monitor water consumption and detect possible problems with the compound water meter or the water flowing therethrough. Although not shown in FIGS. 1 and 2, the sensor data obtained from the sensors may be analyzed by a processing device, which is: (a) communicatively coupled to the sensors for receiving the sensor data obtained thereby, and (b) configured to execute program instructions to analyze the sensor data. In some embodiments, the sensor data received by the processing device may be analyzed in real-time (or may be stored and analyzed later) to monitor water consumption, detect pressure, temperature and/or water quality issues of the water flowing through the compound water meter and/or detect potential problems within the compound water meter (such as, e.g., register failures, mechanical failures, crossover failures, bypass open conditions, incorrect sizing of flow meters, as well as many others). Examples of how the sensor data obtained from the sensors may be analyzed to detect problems within the compound water meter, which would not have been detected through monitoring of water consumption alone, are described in the co-pending application.

Flow meters, both new and old, can fail to accurately report fluid measurement data for a variety of reasons. For example, a flow meter may underreport fluid flow due to incorrect sizing of the flow meter, leaks within the pipes, tamper attempts, or mechanical failures of parts within the flow meter or valves within the compound water meter. A bypass open condition is one example of a tamper attempt or a mechanical failure, which may cause significant underreporting of fluid measurement data. In the compound water meters (110, 210) shown in FIGS. 1 and 2, for example, a customer may attempt to obtain free water by opening the bypass valve (120, 220) and fully or partially closing the main valve (122,222), which redirects water flow through the bypass section (112, 212) and bypasses the flow meters (124, 126 and 224, 226) in the low flow section (114, 214) and high flow section (116, 216).

In order to detect bypass open conditions in a flow meter, a technician would need to physically inspect the water meter pit to determine the position of the bypass valve (e.g., whether the bypass valve is closed, partially open or fully open). Such inspection may be performed infrequently, or periodically at best, enabling bypass open conditions to go undetected for a significant amount of time. In the compound water meters (110, 210) shown in FIGS. 1 and 2, a pressure sensor and/or a vibration sensor may be included within the bypass section (112, 212), as noted above. In some cases, sensor data obtained from the pressure sensor and/or the vibration sensor may be analyzed by the processing device to detect a bypass open condition. Although sensor data obtained from a pressure sensor and/or a vibration sensor may be used to determine if a bypass valve is open, the sensor data obtained from such sensors cannot be used to accurately detect a bypass open condition unless the main valve (122, 222) is fully closed. If bypass valve (120, 220) is open and the main valve (122, 222) is only partially closed, allowing water flow through both the bypass section (112, 212) and the flow meter(s) (124, 224) in the low flow section (114, 214), it is much more difficult to detect a bypass open condition using only the sensor data obtained from the sensors. There are also conditions (such as the type of metals used for the piping) that can dampen a sensor signal and cause false flags. In either of these cases, the sensor results would need to be verified.

To overcome the disadvantages noted above, an improved system and method is provided herein to determine the position of one or more valves utilized in a water pipe distribution system. In some embodiments, the system and method disclosed herein may be used to determine the position of a bypass valve included within a compound water meter, such as the bypass valves 120 and 220 included within compound water meters 110 and 210, respectively. In other embodiments, the disclosed system and method may be used to determine the position of other valves included within a compound meter, such as for example, the main valve 122 shown in FIG. 1 or one or more of the valves 222, 228, 240, 242, 252, 262 and 272 shown in FIG. 2. Although described herein in the context of a compound water meter, the techniques described herein may also be used to determine the position of other valves included within a water pipe distribution system.

FIG. 3 illustrates one embodiment of a system 300 in accordance with the present disclosure. In some embodiments, the system 300 may include a compound water meter 310, at least one camera 320 and a processing device 330, as shown in FIG. 3. In addition to other components, the compound water meter 310 may include at least one valve for controlling water flow through the compound water meter. Examples of compound water meters (110 and 210) having at least one valve are depicted in FIGS. 1 and 2 and described above. Other configurations of compound water meters having at least one valve may also be included within the system 300.

In the system 300 shown in FIG. 3, the at least one valve may have an identifying marker, which can be used to determine the position of the at least one valve. A wide variety of identifying markers may be provided on, or attached to, the at least one valve for such purpose. In some embodiments, the identifying marker may be a reflective device or a reflective material, which is provided on, or attached to, the at least one valve at a fixed location. Examples reflective devices include, but are not limited to, an infrared (IR) device or IR tag. Examples of reflective material include, but are not limited to, reflective tape, reflective paint, light colored materials (e.g., white, gold, silver, etc.) that do not significantly absorb light, etc. Some reflective materials containing Zinc Selenide (ZnSe), Zinc Sulfide (ZnS), Sodium Chloride (NaCl), Germanium (Ge), Silicon (Si), and others may be utilized. These can be tapes, paints, markers, glass without coatings of anti-reflective (AR), thermal films and coatings which can be baked or cured, and more.

The identifying marker may be implemented as a reflective device or reflective material in certain embodiments, such as when the compound water meter is installed in a location without sufficient ambient light (e.g., a water meter pit). However, the identifying marker is not strictly limited to reflective devices and materials in all embodiments. When the compound water meter is installed in a location with sufficient ambient light (e.g., outside), or when artificial light is provided, the identifying marker may comprise any identifiable feature of/on the at least one valve (e.g., a valve component, a marking on the valve, etc.) or any identifiable device or material attached to the at least one valve (e.g., a tag, paint, tape, etc.).

FIGS. 1 and 2 illustrate example embodiments of compound water meters (110, 210) having one or more valves for controlling water flow through the compound water meter, wherein at least one of the valves has an identifying marker as described herein. Although FIGS. 1 and 2 illustrate identifying markers provided on, or attached to, all valves included within the compound water meters 110 and 210, the inclusion of identifying markers on all valves (and the placement thereon) is exemplary, provided for illustrative purposes and non-limiting.

In some embodiments, an identifying marker (121, 221) may be provided on a bypass valve (120, 220), which is coupled to a bypass section (112, 212) of a compound water meter (110, 210) to control water flow through the bypass section. When coupled to a bypass valve, the identifying marker (121, 221) may be utilized to determine the position of the bypass valve and monitor for bypass open conditions.

In some embodiments, identifying marker(s) may be provided on one or more valves, which are used to control water flow through the high flow and/or low flow sections of a compound water meter. In the compound water meter 110 shown in FIG. 1, for example, an identifying marker 123 may be provided on the main valve 122, which is used to control water flow through the low flow section 114 and the high flow section 116. In the compound water meter 210 shown in FIG. 2, identifying marker(s) (223, 227, 244 and 246) may be provided on one or more valves (222, 228) used to control water flow through the high flow section 216 and/or one or more valves (240, 242) used to control water flow through the low flow section 214. When coupled to a valve within the low flow or high flow sections, the identifying marker may be utilized to determine a position of a valve in the low flow and/or high flow sections and monitor for changes in position and/or tampering of the valve. By monitoring the position of a valve within the low flow or high flow sections, the techniques described herein can be used to provide an early detection of theft or potential cause of meter damage.

In some embodiments, identifying marker(s) may be provided on one or more valves, which are used to control water flow into/through one or more test ports of a compound water meter. In the compound water meter 210 shown in FIG. 2, for example, identifying marker(s) (254, 264, 274) may be provided on one or more valves (252, 262 and 272) used to control water flow into/through the first test port 250, the second test port 260 and/or the third test port 270. When coupled to a valve within a test port section, the identifying marker may be utilized to determine a position of a valve in the test port and monitor for changes in the position and/or tampering of the valve. By monitoring the position of a valve within a test port section, the techniques described herein can be used to prevent water loss from the test ports and reduce the potential risk from outside environmental factors.

In the system 300 shown in FIG. 3, the at least one camera 320 is coupled to capture images of the at least one valve over time. A variety of camera systems may be utilized to capture the images of the at least one valve. In some embodiments, the at least one camera 320 may be configured to capture moving images of the at least one valve continuously over time (such as, e.g., timelapse or a video feed). In other embodiments, the at least one camera 320 may be configured to capture still images of the at least one valve periodically over time (such as, e.g., every x hours, once a day, once a week, etc.). In some embodiments, the at least one camera 320 may have an infrared (IR) light source and photodetector, which is capable of capturing images in low/no ambient light conditions. In other embodiments, the least one camera 320 may have a visible spectrum light source and photodetector, which is capable of capturing images in the presence of ambient light or an artificial light source.

The type of camera system utilized for the at least one camera 320 may generally depend on the location of the compound water meter 310 and the at least one camera 320, as well as the available light in such a location. When the compound water meter 310 and the at least one camera 320 are disposed below ground within a water meter pit, for example, the at least one camera 320 may be an IR camera (or an IR video camera) having an IR light source and photodetector. When the compound water meter 310 and the at least one camera 320 are disposed above ground (e.g., outside), or an artificial light source is provided, the at least one camera 320 may be a camera (or a video camera) having a visible spectrum light source and photodetector. In some embodiments, the at least one camera 320 may be configured to capture images over a wide range of lighting conditions ranging from full light to no light.

FIGS. 1 and 2 illustrate example embodiments of compound water meters (110, 210), which are disposed below ground within a water meter pit (100, 200). In the embodiment shown in FIG. 1, a camera 140 is mounted to at least one inner surface 105 (e.g., a wall, ceiling, etc.) of the water meter pit 100 and positioned to capture images of at least one valve (e.g., valve 120 and/or 122) included within the compound water meter 110. It is noted that the placement of the camera 140 in FIG. 1 is exemplary, and that the camera 140 may be alternatively mounted at any location within the water meter pit and/or alternatively positioned within the water meter pit, so that the at least one valve (120 and/or 122) is within a field of view (FOV) of the camera 140. In some cases, a single camera may be disposed within the water meter pit 100 to capture images of one valve or a plurality of valves. It is further noted that more than one camera may be disposed within the water meter pit 100 to capture images of the at least one valve (120 and/or 122).

In the embodiment shown in FIG. 2, a plurality of cameras (e.g., 280, 282 and/or 284) are mounted to inner surfaces 205 (e.g., a wall, ceiling, etc.) of the water meter pit 200 and positioned to capture images of at least one valve (e.g., one or more of valves 220, 222, 228, 240, 242, 252, 262 and 272) included within the compound water meter 210. It is noted that the number and placement of the cameras shown in FIG. 2 is exemplary, and that the plurality of cameras may be alternatively mounted and/or positioned, so that the at least one valve (220, 222, 228, 240, 242, 252, 262 and/or 272) is within a field of view (FOV) of the cameras. Multiple cameras may be utilized for a variety of reasons. In some embodiments, for example, a first camera may be positioned to capture images from a first subset of valves, a second camera may be positioned to capture images from a second subset of valves, etc. In other embodiments, multiple cameras may be positioned within the water meter pit 200 to capture images of one more valves in greater detail and/or to focus on one or more areas of concern.

The at least one camera 320 may be alternatively arranged when the compound water meter 310 and the at least one camera 320 are disposed above ground. In some embodiments, the at least one camera 320 may be mounted to a solar panel (not shown), which is coupled to provide power to one or more components of the compound water meter, when the compound water meter is disposed above ground (e.g., outside). In other embodiments, the at least one camera 320 may be mounted to substantially any above ground mounting surface (e.g., a pole, a water pipe, a tree, a fence, a building, under easements and overhangs, etc.) when the compound water meter is disposed above ground (e.g., outside).

In the system 300 shown in FIG. 3, processing device 330 is coupled to receive the images captured by the at least one camera 320 via a wired or wireless connection. As shown in FIG. 3 and described in more detail below, the processing device 330 is configured to execute program instructions 350 stored within a computer readable medium 340 to determine a position of the at least one valve in the images. In some embodiments, data 360 may also be stored within the computer readable medium 340. Examples of data 360 that may be stored within the computer readable medium 340 are discussed in more detail below.

It is noted that processing device 330 can be implemented in a wide variety of manners. In one embodiment, processing device 330 may include one or more programmable integrated circuits, which are programmed to provide the functionality described herein. For example, processing device 330 may include one or more processors (e.g., a microprocessor, microcontroller, central processing unit (CPU), digital signal processor (DSP), etc.), programmable logic devices (e.g., a complex programmable logic device (CPLD), field programmable gate array (FPGA), etc.), and/or other programmable integrated circuits (e.g., an application specific integrated circuit (ASIC), Tensor Processing Unit (TPU), etc.), which execute the program instructions 350 stored within the computer readable medium 340 to implement the functionality described herein.

It is further noted that computer readable medium 340 may be implemented as one or more non-transitory computer readable mediums. Examples of a non-transitory computer readable medium include, but are not limited to, computer readable memory (e.g., read only memory (ROM), random access memory (RAM), flash memory, etc.) and computer readable storage devices (e.g., hard disk drives (HDD), solid state drives (SDD), floppy disks, DVDs, CD-ROMs, etc.). Other variations could also be implemented.

In some embodiments, processing device 330 may be a local processing device located near the compound water meter (e.g., within the water meter pit). In other embodiments, processing device 330 may be a remote processing device located away from the compound water meter (e.g., within a cloud-based computer or server). When a remote processing device is utilized, the compound water meter may further include a communications device (not shown), which may be coupled to receive the images from the at least one camera 320 and configured to communicate the images to the remote processing device via a network (such as Cellular or the Internet). In some embodiments, the communication device may also be coupled to receive sensor data from one or more sensors included within the compound water meter, and may be configured to communicate the sensor data to the remote processing device via the network. The communications device may be configured to transmit the images and/or the sensor data to the remote processing device using a wide variety of communication standards, protocols and/or technologies, including but not limited to, radio frequency (RF) and cellular communication standards, IEEE 802.11 (Wi-Fi), IEEE 802.15.1 (Bluetooth or BLE), and IEEE 802.15.4 (ZigBec).

In the present disclosure, processing device 330 is coupled to receive the images captured by the at least one camera 320 and configured to execute the program instructions 350 to detect the location of one or more identifying markers in the images and determine a position of the at least one valve based on the location of the identifying marker(s) detected in the images. As noted above and shown in FIGS. 1 and 2, an identifying marker may be provided on, or attached to, at least valve of a compound water meter to mark the position of the at least one valve. A wide variety of identifying markers may be utilized for such purpose. In some embodiments, additional identifying marker(s) may be provided on, or attached to, other locations within the compound water meter (e.g., on another valve, a flow meter, a section of pipe, etc.) or elsewhere within the water meter pit.

A wide variety of techniques may be used to detect the location of the identifying marker(s) in the images captured by the at least one camera 320. In one embodiment, processing device 330 may execute program instructions 350 to detect the location of one or more identifying markers in an image by: dividing the image into a pixel grid (i.e., a grid of pixels), assigning an (x, y) coordinate system to the pixel grid and determining the (x, y) coordinates in the pixel grid that correspond to the location of the identifying marker(s) in the image. In another embodiment, the image may be converted into a binary image (i.e., an image containing only ‘1’s and ‘0’s) before dividing the binary image into a pixel grid (in this case, a grid of binary pixels), assigning an (x, y) coordinate system assigned to the pixel grid and determining the (x, y) coordinates in the pixel grid that correspond to the location of the identifying marker(s) in the image. Next, processing device 330 may execute program instructions 350 to determine the position of at least one valve based on the (x, y) coordinates that correspond to the location of the identifying marker(s) detected in the image. In some embodiments, processing device 330 may execute program instructions 350 to detect a change in the position of the at least one valve and may generate an alert in response to the change.

As shown in FIG. 3, computer readable medium 340 may store program instructions 350 and data 360. In some embodiments, the images, pixel grids, (x, y) coordinates and/or valve positions determined based on the (x, y) coordinates may be stored (at least temporarily) within the computer readable medium 340 as data 360. In some embodiments, image regionalization may be used to reduce the amount of data 360 stored within the computer readable medium 340 and/or the computational load placed on the processing device 330 to process and analyze the images. Image regionalization (i.e., the spatial classification of an image into sub-regions) is a technique that may be used to subdivide an image into a grid of local blocks of pixels. When image regionalization is utilized, analysis may be performed on the pixel blocks to identify the pixel block(s) containing the location of the one or more identifying markers. This enables pixel blocks not containing the location of the identifying marker(s) to be removed from the data set, thereby reducing the amount of data 360 stored within the computer readable medium 340 and/or the computational load placed on the processing device 330. In some embodiments, the data 360 may be securely communicated, via one or more networks, to a cloud-based system for archiving or further analysis, if needed.

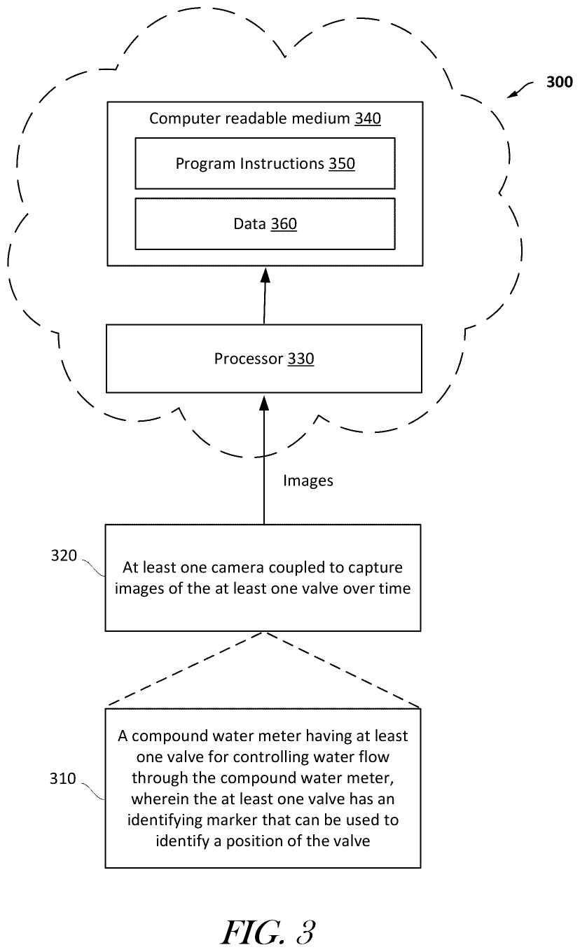

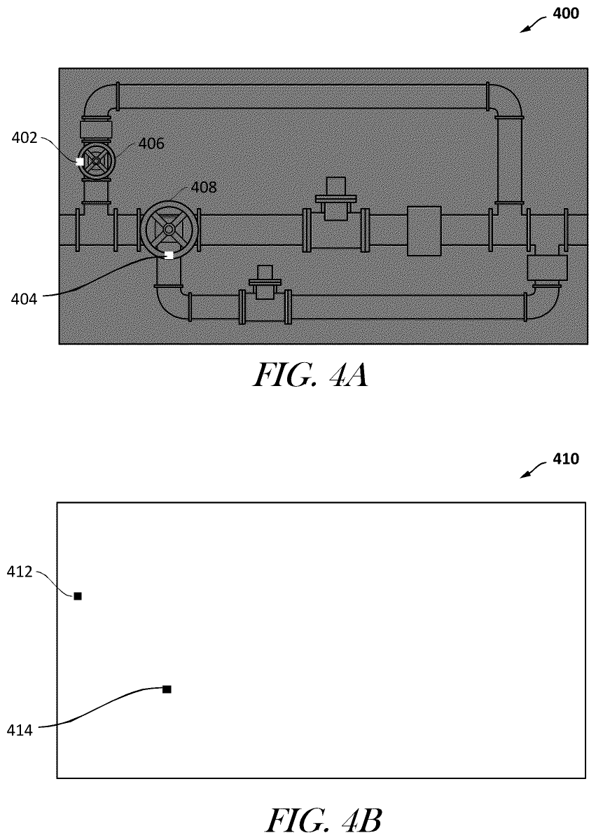

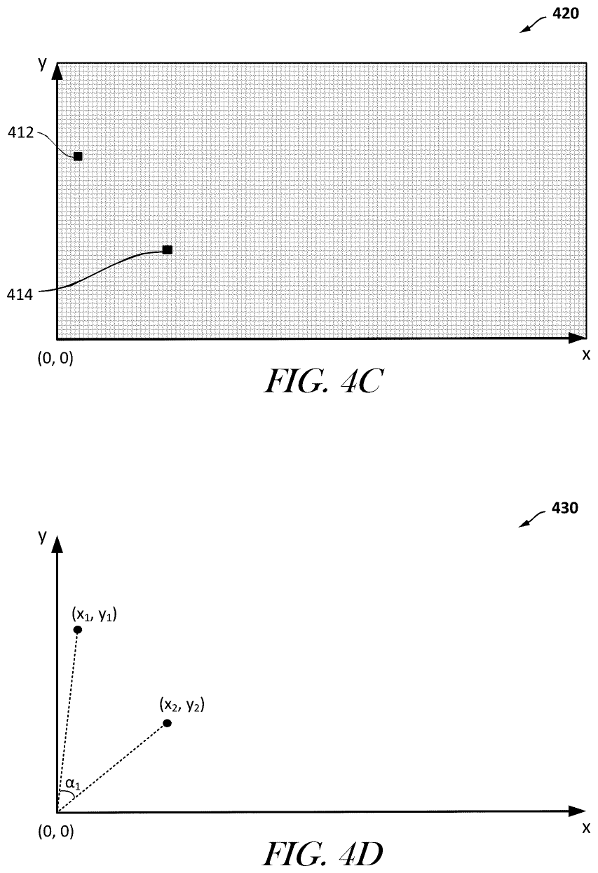

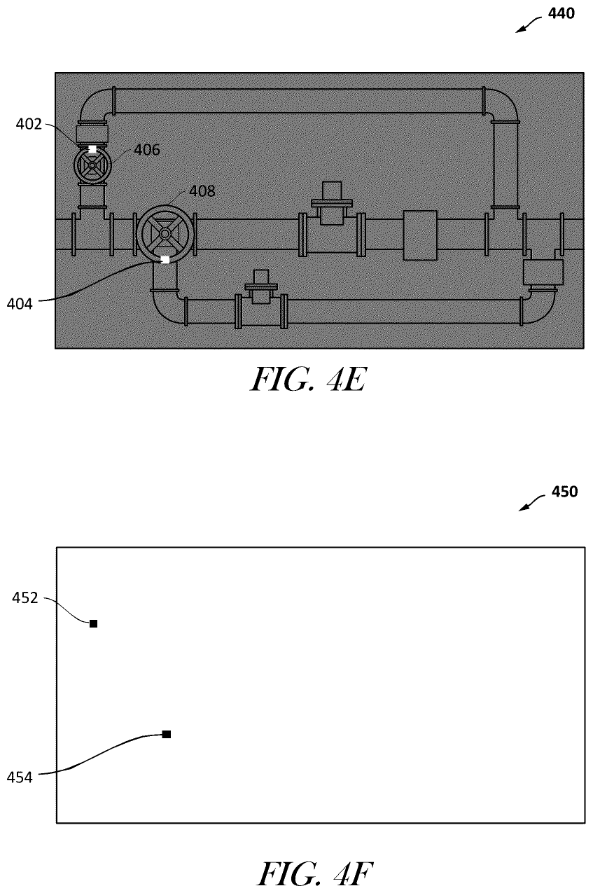

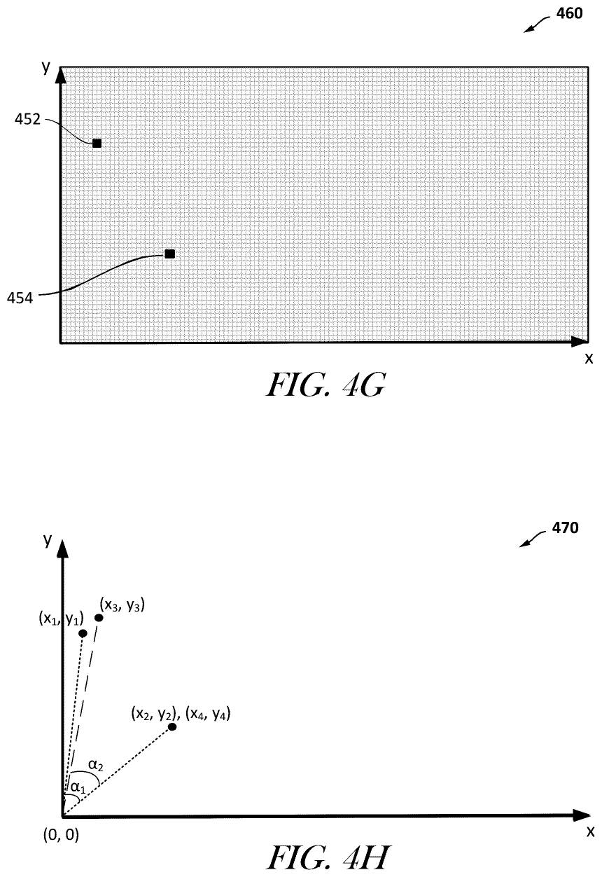

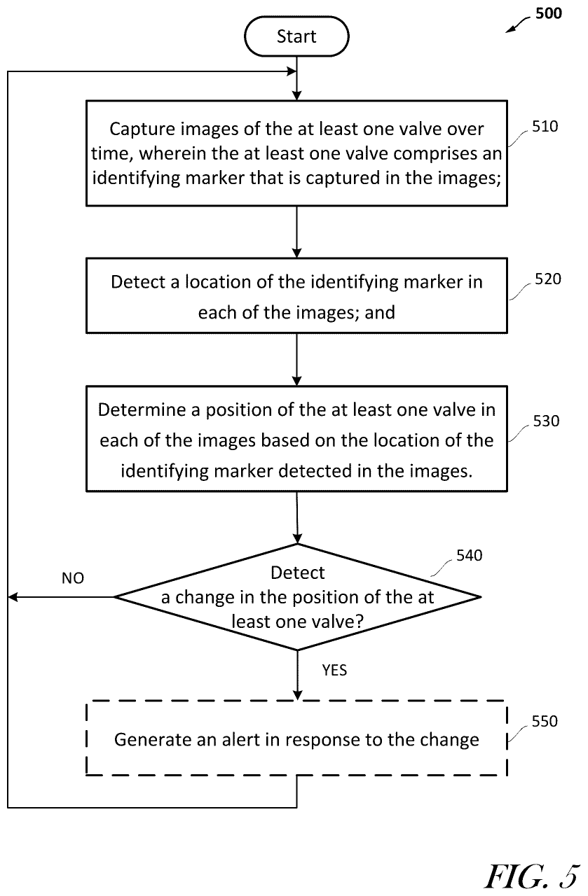

FIGS. 4A-4H illustrate how the techniques disclosed herein may be utilized, in accordance with one various embodiments of the present disclosure, to detect the location of one or more identifying markers in the images captured by the at least one camera 320, and determine a position of at least one valve based on the location of the identifying marker(s) detected in the images. The embodiments shown in FIGS. 4A-4H illustrate various processing steps that may be performed by the processing device 330 executing program instructions 350 to determine the position of at least one valve (e.g., open, closed or partially open) based on the location of identifying marker(s) provided on, or attached to, the valve(s). In the particular embodiments shown in FIGS. 4A-4H, identifying markers are provided on the bypass valve 120 and the main valve 122 positioned at the junction of the high flow section 116 and the low flow section 114 of the compound water meter 210 shown in FIG. 1. It is recognized, however, that identifying marker(s) may additionally or alternatively be provided at other locations within the compound water meter (e.g., on other valves, a flow meter, a section of pipe, etc.) or elsewhere within the water meter pit.

To monitor the position of at least one valve, the at least one camera 320 may be configured to capture images of the at least one valve over time. For example, the at least one camera 320 may capture: (a) a first image of an identifying marker(s) at a first time (e.g., when the camera is initially installed, after maintenance is performed on the compound water meter, etc.), and (b) a second image of the identifying marker(s) at a second time, which is greater than the first time (e.g., a day later, a week later, etc.). Additional images may be captured by the at least one camera 320 on a periodic basis. As each image is captured, the image is provided to the processing device 330 for further processing and analysis.

FIG. 4A represents a first image 400 that may be captured by the at least one camera 320 at a first time. More specifically, FIG. 4A is a drawing of an example first image 400 that may be obtained by a camera disposed within a water meter pit when identifying markers 402, 404 are provided on, or attached to, valves 406, 408 of a compound water meter disposed within the water meter pit. Due to the low ambient light conditions within the water meter pit, the first image 400 may be captured by an IR camera having an IR light source and photodetector. Because the identifying markers 402, 404 provided on, or attached to, the valves 406, 408 are reflective, the identifying markers 402, 404 are depicted in the first image 400 as bright spots on an otherwise dark background. This contrast enables the location of the identifying markers 402, 404 to be easily detected using the techniques described herein.

After receiving the first image 400 shown in FIG. 4A, processing device 330 may execute the program instructions 350 to determine the (x, y) coordinates corresponding to the location of the identifying markers 402, 404 in the first image 400. In some embodiments, the processing device 330 may convert the first image 400 to a binary image 410 (i.e., an image containing only ‘1’s and ‘0’s), as shown in FIG. 4B. In the example binary image 410 shown in FIG. 4B, the pixels 412, 414 corresponding to the identifying markers 402, 404 are converted to ‘1’s (i.e., black pixels), while all other pixels in the first image 400 are converted to ‘0’s (i.e., white pixels). Alternative procedures for converting the first image 400 into a binary image may also be used. In other embodiments, the processing step of converting the first image 400 to the binary image 410 may not be necessary and, thus, may be omitted.

After the first image 400 is captured (or a binary image 410 of the first image 400 is generated), the processing device 330 may divide the first image 400 (or the binary image 410) into a pixel grid 420 and assign an (x, y) coordinate system to the pixel grid 420, as shown in FIG. 4C. Next, the processing device 330 may determine the (x, y) coordinates in the pixel grid 420 that correspond to the location of the identifying markers 402, 404 in the first image 400. In the example embodiment 430 shown in FIG. 4D, the processing device 330 may determine: (a) the location of the identifying marker 402 in the first image 400 by determining the (x₁, y₁) coordinates that correspond to the pixels 412 in the pixel grid 420, and (b) the location of the identifying marker 404 in the first image 400 by determining the (x₂, y₂) coordinates that correspond to the pixels 414 in the pixel grid 420. After obtaining the (x, y) coordinates corresponding to the location of the identifying markers 402, 404 from the first image 400, as shown in FIG. 4D, the processing device 330 may execute the program instructions 350 to assign an initial valve position to at least one of the valves 406, 408 depicted in the first image 400.

In some embodiments, the processing device 330 may assign an initial valve position (e.g., closed) to the valve 406 (i.e., the bypass valve) depicted in the first image 400 based on the (x₁, y₁) coordinates determined in FIG. 4D. In other embodiments, the processing device 330 may assign an initial valve position (e.g., closed) to the valve 406 (i.e., the bypass valve) depicted in the first image 400 based on an angle (α₁) measured between the (x₁, y₁) coordinates, the (x₂, y₂) coordinates and a reference point (e.g., (0, 0)), as shown in FIG. 4D. Initial valve positions may also be determined for other valves in the compound water meter having identifying markers. In some embodiments, for example, the processing device 330 may assign an initial valve position (e.g., open or partially open) to the valve 408 (e.g., the valve provided between the low flow and high flow sections of the compound water meter) depicted in the first image 400 based on: (a) the (x₂, y₂) coordinates determined in FIG. 4D, or (b) the angle (α₁) measured between the (x₁, y₁) coordinates, the (x₂, y₂) coordinates and the reference point (e.g., (0, 0)), as shown in FIG. 4D.

After the initial valve position(s) are determined and assigned to at least one valve, as discussed above, the at least one camera 320 may continue to capture images of the at least one valve. For example, the at least one camera 320 may capture a second image of the at least one valve at a second time, which is greater than the first time. As noted above, the second image may be captured a day later, a week later, etc., to monitor the position of the at least one valve.

FIG. 4E represents a second image 440 that may be captured by the at least one camera 320 at a second time. More specifically, FIG. 4E is a drawing of an example second image 440 that may be obtained by a camera disposed within the water meter pit when identifying markers 402, 404 are provided on, or attached to, valves 406, 408 of a compound water meter disposed within the water meter pit. Like the first image 400 shown in FIG. 4A, the second image 440 shown in FIG. 4E may be captured by an IR camera having an IR light source and photodetector, due to the low ambient light conditions within the water meter pit. Because the identifying markers 402, 404 provided on, or attached to, the valves 406, 408 are reflective, the identifying markers 402, 404 are depicted in the second image 440 as bright spots on an otherwise dark background.

After receiving the second image 440 shown in FIG. 4E, processing device 330 may execute the program instructions 350 to determine the (x, y) coordinates corresponding to the location of the identifying markers 402, 404 in the second image 440. The (x, y) coordinates corresponding to the location of the identifying markers 402, 404 in the second image 440 may be determined, as discussed above. In some embodiments, the processing device 330 may convert the second image 440 to a binary image 450 by converting the pixels 452, 454 corresponding to the identifying markers 402, 404 to ‘1’s (i.e., black pixels), while all other pixels in the second image 440 are converted to ‘0’s (i.e., white pixels), as shown in FIG. 4F. In other embodiments, the processing step of converting the first image 400 to the binary image 410 may be omitted, as discussed above.

After the second image 440 is captured (or a binary image 450 of the second image is generated), the processing device 330 may divide the second image 440 (or the binary image 450) into a pixel grid 460 and assign an (x, y) coordinate system to the pixel grid 460, as shown in FIG. 4G. Next, the processing device 330 may determine the (x, y) coordinates in the pixel grid 460 that correspond to the location of the identifying markers 402, 404 in the second image 440. In the example embodiment 470 shown in FIG. 4H, the processing device 330 may determine: (a) the location of the identifying marker 402 in the second image 440 by determining the (x₃, y₃) coordinates that correspond to the pixels 452 in the pixel grid 460, and (b) the location of the identifying marker 404 in the second image 440 by determining the (x₄, y₄) coordinates that correspond to the pixels 454 in the pixel grid 460. After obtaining the (x, y) coordinates corresponding to the location of the identifying markers 402, 404 in the second image 440, as shown in FIG. 4H, the processing device 330 may execute the program instructions 350 to determine whether the position of at least one valve has changed between the first image 400 and the second image 440.

In some embodiments, the processing device 330 may determine whether the position of the at least one valve has changed by comparing the (x, y) coordinates obtained from the second image 440 with the (x, y) coordinates obtained from the first image 400 for the identifying marker provided on the at least one valve. If the (x, y) coordinates obtained from the first and second images 400, 440 are substantially the same (e.g., within a tolerance amount), the processing device 330 may determine that the position of the valve depicted in the second image 440 is identical to the initial valve position, which was previously assigned to the valve based on the (x, y) coordinates obtained from the first image 400. As shown in FIG. 4H, the (x₂, y₂) coordinates obtained from the first image 400 and the (x₄, y₄) coordinates obtained from the second image 440 are substantially the same. Based on such, the processing device 330 may determine that the position of the valve 408 has not changed. On the other hand, if the (x, y) coordinates obtained from the second image 440 differ (by more than the tolerance amount) from the (x, y) coordinates obtained from the first image 400, the processing device 330 may determine that the position of the valve depicted in the second image 440 has changed from the initial valve position. As shown in FIG. 4H, the (x₁, y₁) coordinates obtained from the first image 400 and the (x₃, y₃) coordinates obtained from the second image 440 are different. Based on such, the processing device 330 may determine that the position of the valve 406 has changed (e.g., from closed to open or partially open).

In other embodiments, the processing device 330 may determine whether the position of the at least one valve has changed by measuring the angle (α₂) between the (x₃, y₃) coordinates, the (x₄, y₄) coordinates and the reference point (e.g., (0, 0)), as shown in FIG. 4H, and by comparing the angle (α₂) with the angle (α₁) measured between the (x₁, y₁) coordinates, the (x₂, y₂) coordinates and the reference point (e.g., (0, 0)), as shown in FIGS. 4D and 4H. If the angles α₁ and α₂ are substantially the same (e.g., within a tolerance amount), the processing device 330 may determine that the position of the valves 406, 408 depicted in the second image 440 are identical to the initial valve positions, which were previously assigned to the valves based on the (x, y) coordinates obtained from the first image 400. If the angles α₁ and α₂ are different, as shown in FIG. 4F, the processing device 330 may determine that the position of at least one of the valves 406, 408 depicted in the second image 440 has changed from its initial valve position.

In the example embodiments described above, the initial valve position of the at least one valve is determined based on the initial (x, y) coordinates obtained from the first image 400 or the initial angle (α₁) measured between the initial (x, y) coordinates and the reference point (e.g., (0, 0)). The (x, y) coordinates (or angle (α)) obtained from each subsequently captured image are then compared to the initial (x, y) coordinates (or initial angle (α₁)) obtained from the first image 400 to determine if the valve position has changed. The (x, y) coordinates obtained over time for a particular valve should not move, or change, positioning unless the position of the valve is physically adjusted. Any deviation between a subsequent (x, y) coordinate and the initial (x, y) coordinate (or a subsequent angle (α) and initial angle (α₁)) may be logged and/or flagged for further review or analysis.

For example, if the processing device 330 detects a minor change in the position of a particular valve, the sensor data obtained from one or more sensors coupled to the compound water meter may be reviewed to confirm the position of the valve and/or determine if anything is out of the ordinary. The sensor data can be reviewed manually, artificially in the Cloud or on the device itself. If the review of the sensor data detects something out of the ordinary, the valve will be flagged as an issue. If the processing device 330 detects a major change in the position of a particular valve (e.g., by several degrees), the sensor data may not need to be reviewed, however, the particular valve will still be flagged as an issue. By utilizing the program instructions 350 to detect valve position and flag valve(s) that have changed position, the processing device 330 described herein may be configured to automatically detect a potential issue with a particular valve as soon as, or shortly after, the issue occurs. This enables a technician to respond quickly to manually inspect the valve and/or correct the issue.

In some embodiments, the processing device 330 may execute the program instructions 350 to generate an alert in response to detecting a change in valve position. Examples of alerts that may be generated include, but are not limited to, notifications via text message, instant messaging, dashboards, email, phone calls, etc. Other alerts not specifically mentioned herein may also be generated in response to detecting a change in valve position. In some embodiments, an alert may be generated in response to detecting a change in the position of a bypass valve. The alert may notify a technician of a bypass open condition. Receiving an alert for a bypass open condition may enable the technician to recognize and correct the bypass open condition in a timely manner, thereby reducing underreporting of water consumption and lost revenue for the water utility. In other embodiments, an alert may be generated in response to detecting a change in the position of other valves within the compound water meter.

As noted above, processing device 330 may use sensor data obtained from one or more sensors coupled to the compound water meter to confirm the position of the at least one valve, in some embodiments. A variety of sensors may be utilized for this purpose. In some embodiments, for example, a pressure sensor may be coupled to a pipe structure controlled by the at least one valve. The pressure sensor senses water pressure within the pipe structure and generates sensor data corresponding to the sensed pressure. In some embodiments, the processing device 330 may use the pressure data obtained from the pressure sensor to confirm the position of the at least one valve. For example, the processing device 330 may analyze pressure data obtained from the pressure sensor to further determine if the at least one valve is closed, open or partially open.

In some embodiments, a vibration sensor may be coupled to the at least one valve, or to a pipe structure controlled by the at least one valve. The vibration sensor senses vibration in the pipe structure indicative of water flow through the pipe structure and generates sensor data corresponding to the sensed vibration. In some embodiments, the processing device 330 may use the sensor data obtained from the vibration sensor to confirm the position of the at least one valve. For example, the processing device 330 may analyze vibration signatures obtained from the vibration sensor to further determine if the at least one valve is closed, open or partially open.

In some embodiments, a motion sensor (such as, e.g., an accelerometer, gyroscope, etc.) may be coupled to the least one valve. The motion sensor senses movement of the at least one valve and generates sensor data corresponding to the sensed movement. In one example, an accelerometer may be coupled to the at least one valve to sense a change in velocity of the at least one valve over time. In another example, a gyroscope may be coupled to the at least one valve to sense a change in the angular velocity of the at least one valve over time. In some embodiments, the processing device 330 may use the sensor data obtained from the motion sensor to confirm the position of the at least one valve. For example, the processing device 330 may analyze sensor data obtained from the motion sensor to determine if the at least one valve has been moved.

FIG. 5 illustrates one embodiment of a method 500 that may be used to determine a position of at least one valve utilized within a water pipe system. In some embodiments, the method 500 shown in FIG. 5 may be used to detect and monitor the position of at least one valve utilized within a compound water meter, such as but not limited to, the compound water meters shown and described herein. In some embodiments, method 500 may begin (in step 510) by capturing images of the at least one valve over time, wherein the at least one valve comprises an identifying marker that is captured in the images. Next, the method may detect a location of the identifying marker in each of the images (in step 520), and may determine a position of the at least one valve in each of the images based on the location of the identifying marker detected in the images (in step 530).

In some embodiments, the method 500 may detect the location of the identifying marker (in step 520) by detecting a first location of the identifying marker in a first image, and detecting a second location of the identifying marker in a second image, which is captured after the first image is captured. The first image may be captured at a first time (e.g., when the camera is initially installed, after maintenance is performed on the compound water meter, etc.), and the second image may be captured at a second time, which is greater than the first time (e.g., a day later, a week later, etc.). Next, the method 500 may determine the position of the at least one valve (in step 530) by: determining a first position of the at least one valve in the first image based on the first location of the identifying marker detected in the first image; and determining a second position of the at least one valve in the second image based on the second location of the identifying marker detected in the second image.

In some embodiments, the method 500 may compare the second position to the first position to determine if the position of the at least one valve has changed (in step 540). If the position of the at least one valve has not changed (NO branch of step 540), the method 500 may continue to monitor the position of the at least one valve by repeating steps 510-540. If the position of the at least one valve has changed (YES branch of step 540), the method 500 may (optionally) generate an alert in response to the change (in step 550) before continuing to monitor the position of the at least one valve by repeating steps 510-540. If generated, an alert may notify a technician that the valve position has changed.

Further modifications and alternative embodiments of the systems and methods described herein will be apparent to those skilled in the art in view of this description. It will be recognized, therefore, that the described systems and methods are not limited by these example arrangements. It is to be understood that the forms of the methods herein shown and described are to be taken as example embodiments. Various changes may be made in the implementations. Thus, although the inventions are described herein with reference to specific embodiments, various modifications and changes can be made without departing from the scope of the present inventions. Accordingly, the specification and figures are to be regarded in an illustrative rather than a restrictive sense, and such modifications are intended to be included within the scope of the present inventions. Further, any benefits, advantages, or solutions to problems that are described herein with regard to specific embodiments are not intended to be construed as a critical, required, or essential feature or element of any or all the claims.

What is claimed is:

1. A system configured to determine a position of one or more valves utilized in a water pipe distribution system, the system comprising:
an identifying marker provided on, or attached to, at least one valve included within a compound water meter for controlling water flow through the compound water meter;
at least one camera coupled to capture images of the at least one valve over time; and
a processing device coupled to receive the images captured by the at least one camera, wherein the processing device is configured to execute program instructions stored within a computer readable medium to detect a location of the identifying marker in the images and determine a position of the at least one valve based on the location of the identifying marker detected in the images.

2. The system as recited in claim 1, wherein the compound water meter and the at least one camera are disposed below ground within a water meter pit, wherein the at least one camera comprises an infrared (IR) light source and photodetector, and wherein the identifying marker comprises a reflective device or a reflective material that is provided on, or attached to, the at least one valve.

3. The system as recited in claim 2, wherein the reflective device or the reflective material is an IR device, a reflective tape, a reflective paint or a light colored material.

4. The system as recited in claim 2, wherein the at least one camera is mounted to an inner surface of the water meter pit and positioned, so that the at least one valve is within a field of view (FOV) of the at least one camera.

5. The system as recited in claim 1, wherein the compound water meter and the at least one camera are disposed above ground, wherein the at least one camera comprises a visible spectrum light source and photodetector, and wherein the identifying marker provided on, or attached to, the at least one valve comprises an identifiable feature of the at least one valve or an identifiable device or material attached to the at least one valve.

6. The system as recited in claim 5, wherein the at least one camera is mounted to a solar panel, which is coupled to provide power to one or more components of the compound water meter, and wherein the at least one camera is positioned, so that the at least one valve is within a field of view (FOV) of the at least one camera.

7. The system as recited in claim 5, wherein the at least one camera is mounted to an above ground mounting surface, and wherein the at least one camera is positioned, so that the at least one valve is within a field of view (FOV) of the at least one camera.

8. The system as recited in claim 1, wherein the at least one valve is a bypass valve, which is coupled to a bypass section of the compound water meter to control water flow through the bypass section, and wherein the processing device executes the program instructions to determine the position of the bypass valve to monitor for bypass open conditions.

9. The system as recited in claim 1, wherein the at least one valve is coupled to a high flow section or a low flow section of the compound water meter, and wherein the processing device executes the program instructions to determine the position of the at least one valve and monitor for changes in the position of the at least one valve.

10. The system as recited in claim 1, wherein the at least one valve is coupled to one or more test ports of the compound water meter, and wherein the processing device executes the program instructions to determine the position of the at least one valve and monitor for changes in the position of the at least one valve.

11. The system as recited in claim 1, wherein the compound water meter comprises a plurality of valves, and wherein the at least one camera comprises a plurality of cameras coupled to capture images of one or more of the plurality of valves over time.

12. The system as recited in claim 1, wherein the program instructions executed by the processing device detect the location of the identifying marker in each image by:
dividing the image into a pixel grid;
assigning an (x, y) coordinate system to the pixel grid; and
determining (x, y) coordinates in the pixel grid that correspond to the location of the identifying marker in the image.

13. The system as recited in claim 12, wherein the program instructions executed by the processing device determine the position of the at least one valve based on the (x, y) coordinates that correspond to the location of the identifying marker detected in the image.

14. The system as recited in claim 1, wherein the program instructions executed by the processing device detect the location of the identifying marker in each image by:
converting the image to a binary image;
dividing the binary image into a pixel grid;
assigning an (x, y) coordinate system to the pixel grid; and
determining (x, y) coordinates in the pixel grid that correspond to the location of the identifying marker in the image.

15. The system as recited in claim 14, wherein the program instructions executed by the processing device determine the position of the at least one valve based on the (x, y) coordinates that correspond to the location of the identifying marker detected in the image.

16. The system as recited in claim 1, wherein the processing device is further configured to execute the program instructions to detect a change in the position of the at least one valve and generate an alert in response to the change.

17. The system as recited in claim 1, wherein the processing device is further configured to use sensor data obtained from one or more sensors coupled to the compound water meter to confirm the position of the at least one valve.

18. The system as recited in claim 17, wherein the one or more sensors comprise one or more of the following sensors:
a pressure sensor coupled to a pipe structure controlled by the at least one valve, wherein the pressure sensor senses water pressure within the pipe structure and generates sensor data corresponding to the sensed water pressure;
a vibration sensor coupled to the at least one valve or the pipe structure controlled by the at least one valve, wherein the vibration sensor senses vibration in the pipe structure indicative of water flow through the pipe structure and generates sensor data corresponding to the sensed vibration; and
a motion sensor coupled to the least one valve, wherein the motion sensor senses movement of the at least one valve and generates sensor data corresponding to the sensed movement.

19. A method to determine a position of at least one valve utilized in a water pipe distribution system, the method comprising:
capturing images of the at least one valve over time, wherein the at least one valve comprises an identifying marker that is captured in the images;
detecting a location of the identifying marker in each of the images; and
determining a position of the at least one valve in each of the images based on the location of the identifying marker detected in the images.

20. The method as recited in claim 19, wherein said detecting the location of the identifying marker comprises:
detecting a first location of the identifying marker in a first image captured at a first time; and
detecting a second location of the identifying marker in a second image captured at a second time, which is greater than the first time.

21. The method as recited in claim 20, wherein said determining the position of the at least one valve comprises:
determining a first position of the at least one valve in the first image based on the first location of the identifying marker detected in the first image; and
determining a second position of the at least one valve in the second image based on the second location of the identifying marker detected in the second image.

22. The method as recited in claim 21, further comprising:
comparing the second position to the first position to determine if the position of the at least one valve has changed; and
generating an alert when the position of the at least one valve changes.
